(19) United States
(12) Patent Application Publication
(10) Pub. No.: US 2015/0362128 A1
(43) Pub. Date: Dec. 17, 2015

(54) DEVICE AND METHOD FOR SUPPLYING FLUID

(71) Applicant: L'Air Liquide, Société Anonyme pour l'Etude et l'Exploitation des Procédés Georges Claude, Paris (FR)

(72) Inventors: Patrick SANGLAN, Seyssins (FR); Martin Staempflin, Quaix en Chartreuse (FR)

(21) Appl. No.: 14/734,973

(22) Filed: Jun. 9, 2015

(30) Foreign Application Priority Data
Jun. 12, 2014 (FR) 1455321

(51) Int. Cl. F17C 7/04; F17C 13/00

(52) U.S. Cl. CPC F17C 7/04; F17C 13/002; F17C 2223/0161; F17C 2223/041; F17C 2223/046; F17C 2225/0107; F17C 2225/036

(57) ABSTRACT

Device for supplying fluid comprising a source tank for storing gaseous fuel at a cryogenic temperature in the form of a liquid-gas mixture, a cryogenic pump, the pump comprising a suction inlet connected to the lower part of the tank via a suction line, a high-pressure first outlet intended to supply high-pressure fluid to a user and a degassing second outlet connected to the upper part of the tank via a return pipe, the device being characterized in that it comprises a cryogenic buffer storage volume, a first pipe connecting the lower part of the buffer storage volume to the tank and a second pipe connecting the upper part of the tank to the buffer storage volume, and in that the device comprises a liquefaction member for liquefying the gas in the buffer storage volume.

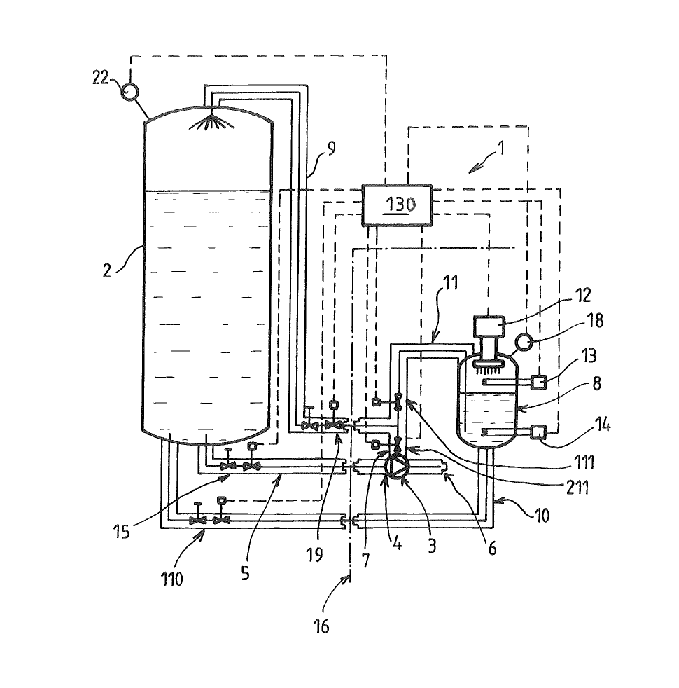

### CROSS REFERENCE TO RELATED APPLICATIONS

This application claims the benefit of priority under 35 U.S.C. §119 (a) and (b) to French Patent Application No. 1455321 filed Jun. 12, 2014, the entire contents of which are incorporated herein by reference.

### BACKGROUND

The present invention relates to a device and a method for supplying fluid.

The invention relates more particularly to a device for supplying fluid comprising a source tank for storing gaseous fuel at a cryogenic temperature in the form of a liquid-gas mixture, a cryogenic pump, the pump comprising a suction inlet connected to the lower part of the tank via a suction line, a high-pressure first outlet intended to supply high-pressure fluid to a user and a degassing second outlet connected to the upper part of the tank via a return pipe.

The invention relates to a device for supplying fluid (liquid or gas) under pressure from a tank of liquid stored at a cryogenic temperature. In order to obtain pressurized gas, the pumped liquid may be vaporized in a vaporizer.

High-pressure cryogenic liquid pumping plants comprising a pump for withdrawing cryogenic liquid from an insulated tank under vacuum and compressing it are faced with the issue of how to manage the boil-off gases (resulting from vaporization) generated. These boil-off gases are generated by the tank, by the pump and the pipework connecting it to the tank, by the pump operating cycles particularly during cooling phases. All of these generated gases are theoretically returned to the tank, ideally in the liquid phase, using a thermosiphon device so that they can be recondensed or alternatively in the gaseous phase when the fluids used make use of a thermosiphon difficult or impossible. This is often the case with low-density and highly volatile fluids such as hydrogen. The quantities of gas generated may be very high, resulting in unwanted increases in pressure in the tank and discharge of hydrogen into the atmosphere. Another consequence of these gas streams returned to the tank is that they increase the pressure in the tank but also the temperature of the fluid, possibly resulting in losses of NPSH (net positive suction head) or suction headloss.

These phenomena need to be taken into consideration particularly when pumping fluids of low molar mass (hydrogen, helium).

Pumping a gas in liquid form is generally more advantageous in terms of energy efficiency than compressing it in gaseous form.

However, pumping liquid hydrogen is a relatively tricky business. Because of its low density and high volatility it is relatively difficult to keep it in liquid form all the way to the pump. This may lead to phenomena of cavitation and gas may be generated in the pump which needs to be returned to the tank. The cryogenic compression of liquid hydrogen is creating a certain amount of interest these days for future hydrogen power applications. This emerging phase of a market is leading to the use of hardware and products from other applications and markets the specifications and performance of which are somewhat incompatible with the planned demonstrations. For example, the time the pump is kept cold needs to be limited to two hours per operation, necessitating heating/cooling cycles that generate significant quantities of gas.

For high-capacity hydrogen compression stations, the quantity of gas generated may be significant and may justify investment in an additional compression station for compressing this produced gas and storing it in a recuperation tank. However, this is detrimental to the economic balance sheet of the installation.

The pump is supplied with liquid from a tank via a suction line and is kept at a low temperature during operation. The gas produced is returned to the tank via a degassing outlet of the pump. This quantity of gas produced is dependent on the thermal performance of the installation and of the pump and the operating cycles.

When the pump is switched off (ambient temperature), the pump and the relevant lines of the circuit for supplying the pump are hot (ambient temperature). The tank under vacuum vaporizes liquid because of the ingress of heat, causing the pressure in the tank to rise.

Before the installation is used, the circuit and the pump need to be cooled. This is performed by pumping liquid which is returned to the tank via the degassing outlet of the pump. This too contributes to increasing the pressure in the tank.

There are two main pumping setups for cryogenic fluids and, in particular, for liquid hydrogen. In a first setup referred to as the “standard” setup the pump draws liquid from the bottom part of the tank and the degassing outlet of the pump is connected to the top part of the tank (gaseous phase). When the tank is full, this may generate significant increases in pressure, requiring degassing to the outside.

In a second setup referred to as being of the “thermosiphon” type, the degassing outlet is connected to the bottom part of the tank (liquid phase). The hotter gas or liquid is returned to the liquid phase where it is reliquefied or cooled. This thermosiphon device makes it possible to limit the increase in pressure in the tank. The pump constitutes the hot source of the thermosiphon. For normal operation, a thermosiphon demands that a certain number of design and installation provisions be observed in order to keep control of headlosses, in order to have enough of a pressure head that is necessary to prime and operate the pump and also in order to ensure that the source of heat is available. In this respect, there may be conflict between the inputs of heat to the pump and the supply pipework which needs to be as low as possible in order to minimize the generation of gas, and the need for heat that is required in order to ensure satisfactory operation of the thermosiphon.

The heat introduced into the liquid part reduces the density of the liquid enough to generate a circulation of liquid of the “thermosiphon” type from the suction side to the degassing outlet of the pump even when the pump is not pumping. For correct operation, the difference in height between the suction point of the pump and the point of return to the tank needs to be adhered to.

This thermosiphon type of setup operates only with difficulty with light fluids such as hydrogen. It is practically impossible to form a natural circulation of the thermosiphon type in a pump with hydrogen, particularly when the tank is almost empty.

### SUMMARY

It is an object of the present invention to alleviate all or some of the abovementioned disadvantages of the prior art.

To this end, the device according to the invention, in other respects in accordance with the generic definition thereof given in the above preamble, is essentially characterized in that it comprises a cryogenic buffer storage volume, a first pipe connecting the lower part of the buffer storage volume to the tank and a second pipe connecting the upper part of the tank to the buffer storage volume, and in that the device comprises a liquefaction member for liquefying the gas in the buffer storage volume.

Moreover, some embodiments of the invention may comprise one or more of the following features:
the first pipe is distinct from the suction line,
the second pipe may form or comprise a tube allowing liquid to be transferred between the buffer storage volume and the tank,
the pump is configured to operate in two directions (the flow of liquid can be reversed),
the second pipe has a first end connected to the upper part of the buffer storage volume and a second end connected to the return pipe, which means to say that the buffer storage volume is connected to the tank and to the second outlet of the pump via the return pipe,
the buffer storage volume comprises at least one heater for selectively heating the fluid contained in the buffer storage volume with a view to increasing the pressure therein,
the buffer storage volume comprises two heaters arranged respectively in the upper and lower parts of the storage volume,
of: the suction line, the return pipe, the first pipe, the second pipe, at least one comprises at least one valve, notably at least one controlled valve,
the device comprises a data acquisition, storage and processing member connected to the at least one valve and to the liquefaction member,
the data acquisition, storage and processing member is also connected to the heater(s), the data acquisition, storage and processing member being configured to control the liquefaction member, the at least one heater and the at least one valve in order to liquefy, in the buffer storage volume, at least some of the gas vaporized in the device,
the data acquisition, storage and processing member is configured to control the liquefaction member, the at least one heater and the at least one valve in order to keep the pressure in the tank below a determined threshold pressure,
the device comprises at least one of the following: a pressure sensor sensing the pressure in the tank, a temperature sensor sensing the temperature in the tank, a pressure sensor sensing the pressure in the buffer storage volume, a temperature sensor sensing the temperature in the storage volume, the said at least one sensor being connected to the data acquisition, storage and processing member,
the pump has a determined suction headloss (NPSH), the data acquisition, storage and processing member being configured to control the liquefaction member, the at least one heater and the at least one valve in order to keep the pressure in the tank or in the suction line at least equal to the saturation pressure of the cryogenic fluid increased by the suction headloss (NPSH) of the pump and possibly also increased by the value of the headlosses caused by the pipework of the suction line connecting the tank to the pump,
the end of the return pipe comprises a multi-jet splitter nozzle,
the liquefaction member comprises a cryocooler.

The invention also relates to a method for supplying fluid using a fluid supply device according to any one of the features hereinabove or hereinbelow comprising, during a period in which the pump is switched off and when the pressure in the tank reaches a determined threshold, a step of transferring vaporized gas from the tank to the buffer storage volume, and a liquefaction step in which transferred gas is liquefied in the buffer storage volume by the liquefaction member.

According to other possible features:
when the liquid level in the buffer storage volume reaches a set limit level, liquid is transferred from the buffer storage volume to the tank,
at least one transfer of fluid between the buffer storage volume and the tank (in one or both directions) is performed by establishing a pressure differential between the pressures within the buffer storage volume and the tank and by placing these latter in fluidic communication (by the opening of (a) valve(s)),
the method comprises a step of cooling the pump by transferring liquid from the buffer storage volume to the tank via the second outlet of the pump, the inlet of the pump and the suction pipe,
the method comprises a step of switching on and cooling the pump by transferring liquid from the tank to the buffer storage volume via the suction pipe, the inlet of the pump and an outlet of the pump, at least part of the gas vaporized in the buffer storage volume being liquefied by the liquefaction member,
the method comprises a pumping step in which, when the pressure in the buffer storage volume is below the pressure in the tank, liquid is pumped from the tank via the inlet and the second outlet of the pump is fluidically connected to the buffer storage volume,
the method comprises a step of pumping liquid from the tank during which step at least some of the fluid vaporized in the pump is transferred from the high-pressure second outlet of the pump to the buffer storage volume and is liquefied by the liquefaction member.

The invention may relate also to any alternative device or method comprising any combination of the features hereinabove or hereinbelow.

### BRIEF DESCRIPTION OF THE DRAWINGS

Other specifics and advantages will become apparent from reading the description hereinafter, made with reference to the single FIGURE which depicts a schematic and partial view illustrating the structure and operation of a device for supplying fluid according to one embodiment of the invention.

### DESCRIPTION OF PREFERRED EMBODIMENTS

The device for supplying fluid comprises a source tank 2 for storing gaseous fuel at a cryogenic temperature in the form of a liquid-gas mixture. The tank 2 is preferably of the double-walled type with an insulating vacuum between the two walls.

The device comprises a cryogenic pump 3 equipped with a suction inlet 4 connected to the lower part of the tank 2 via a suction line 5.

The pump 3 comprises a high-pressure first outlet 6 intended to supply pressurized fluid (liquid) to a user and a degassing second outlet 7. The degassing outlet 7 is connected to the upper part of the tank 2 via a return pipe 9. For example, the end of the return pipe 9 comprises a multi-jet distribution nozzle 17 in the upper part of the tank 2.

The device 1 further comprises a distinct cryogenic buffer storage volume 8 and a first pipe 10 connecting the lower part of the buffer storage volume 8 to the tank 2, preferably to the bottom part of the tank 2. The device 1 comprises a second pipe 11 connecting the top part of the tank 2 to the buffer storage volume 8, preferably to the top part of the buffer storage volume 8. In addition, the buffer storage volume 8 comprises a liquefaction member 12 for liquefying the gas in the buffer storage volume 8, for example a cryocooler.

The buffer storage volume 8 preferably comprises at least one heater and, more preferably still, two 13, 14, for selectively heating the fluid contained in the buffer storage volume 8 with a view to increasing the pressure therein. The two heaters are positioned for example respectively in the upper and lower parts of the buffer storage volume 8.

As illustrated, the second pipe 11 may comprise a first end connected to the upper part of the buffer storage volume 8 and a second end connected to the return pipe 9. What that means to say is that the buffer storage volume 8 is connected to the tank 2 and to the second outlet 7 of the pump 3 via the return pipe 9. As illustrated schematically, all or some of the pipes and lines may have removable-connection ends, for example along a zone 16 of connection between, on the one hand, the parts connected to the tank 2 and, on the other hand, the parts connected to the buffer storage volume 8 and to the pump 3. The pump 3 and the buffer storage volume 8 are ideally arranged in such a way as to minimize the length of the connecting piping 10 and 11 and the headlosses and additional and unwanted inputs of heat. The pump 3 is, for example, a standard commercially available pump. In the future, it is possible to use a pump 3 developed specifically for this application and the design of which will allow it to be immersed in the buffer storage tank 8, eliminating the need for connecting piping. Of: the suction line 5, the return pipe 9, the first pipe 10, the second pipe 11, at least one comprises at least one valve 15, 19, 110, 111, 211, notably at least one controlled valve. For example, the suction line 5 comprises one or two valves 15. The first pipe 10 may comprise one or two valves 110. The second pipe 11 may comprise a valve 111. The degassing pipe 9 may comprise one or two valves 19. Likewise, the degassing outlet 7 of the pump 3 may comprise a valve 211 upstream of the junction between the return pipe 9 and the second pipe 11.

For preference, the device also comprises a data acquisition, storage and processing member 130 connected (wirelessly and/or as a wired connection) to the valves 15, 19, 110, 111, 211 and to the liquefaction member 12.

The data acquisition, storage and processing member 130 may also be connected to the heater(s) 13, 14.

The data acquisition, storage and processing member 130 may comprise a microprocessor, a computer, or any other device suited to be configured (programmed) to control the liquefaction member 12, the at least one heater 13, 14 and the valves 15, 19, 110, 111, 211.

In particular, the device may be configured to control the liquefaction, in the buffer storage volume 8, of at least some of the gas vaporized in the device (namely the gas produced in the tank or the pump or the circuit).

Likewise, the data acquisition, storage and processing member 130 may be configured to control the liquefaction member 12, the at least one heater 13, 14 and the valve or valves 15, 19, 110, 111, 211 so as to keep the pressure in the tank 2 below a determined pressure threshold.

Advantageously, the device may comprise at least one of the following: a pressure sensor 22 sensing the pressure in the tank 2, a temperature sensor sensing the temperature in the tank 2, a pressure sensor 18 sensing the pressure in the buffer storage volume 8, a temperature sensor sensing the temperature in the buffer storage volume 8, the said at least one sensor 18, 22 preferably being connected to the data acquisition, storage and processing member 130.

The pump 3 has a determined and known suction headloss (NPSH). The data acquisition, storage and processing member 130 may notably be configured to control the liquefaction member 12, the heater or heaters 13, 14 and the valve or valves 15, 19, 110, 111, 211 in order to keep the pressure in the tank 2 or in the suction line 5 at least equal to the saturation pressure of the cryogenic fluid increased by the suction headloss (NPSH) of the pump 3 and possibly also increased by the value of the headlosses due to the piping of the suction line 5 connecting the tank 1 to the pump.

The structure and operation of the device according to the invention offer numerous advantageous over the known solutions. For example, and as described more specifically hereinafter, the device is connected to the gaseous phase of the tank 2 via the degassing line 9 and allows the inputs of heat from the tank 2 or any other additional input of heat to be reliquefied in the buffer storage volume 8, thus reducing/controlling the pressure in the tank 2. The specifications of the buffer storage volume 8 and of the liquefaction member 12 are determined as a function of the thermal performance of the pump 3 and of the elements connecting it to the tank 2, and also as a function of its operating cycles. For example, in continuous operation, the liquefaction member 12 and the buffer storage volume 8 could be specified so that the gases generated by the pump 3 and the piping are continuously reliquefied, avoiding returning these gases to the tank 2. During discontinuous operation, the gases generated are systematically returned to the tank 2 where they wait to be reliquefied when the pump 3 is off. This mode of operation allows the size of the liquefaction member 12 and of the buffer volume 8 to be optimized. One of the major advantages of this device is that it remains functional whatever the level of liquid in the tank 2 and above all that it optimizes the conditions under which fluid is supplied to the pump 3.

The device makes it possible to control the pressure in the tank 2 while avoiding discharge to the atmosphere or the use of a compressor and of a recuperation tank.

The setup also allows optimal operation of the pump and notably cooling and liquid supply with a pressure level (NPSH) that is enough to avoid or limit any risk of cavitation regardless of the level in the tank 2.

According to one advantageous feature, the thermosiphon phenomenon can be obtained by managing the pressure in the circuit (rather than the effects of gravity and temperature).

### EXAMPLES

Examples of various modes of operation will now be described hereinafter.

### Installation on Standby

When the device is inactive (off, completely stopped), the pump 3 is inactive and all the valves are preferably closed. The pressure within the tank 2 increases as heat enters. After the valves 19, 111 in the return pipe and in the second pipe 11 have been opened, the buffer storage volume 8 is connected to the gaseous phase of the tank 2. The liquefaction member 12 is able to draw gas from the tank 2 with a view to liquefying it in the buffer storage volume 8. The buffer storage volume 8 thus accumulates liquid, the quantity of which can be measured by a level and/or pressure sensor 18.

This makes it possible to reduce the pressure in the tank 2. When the buffer storage volume 8 is full, the valve 111 in the second pipe 11 can be closed and a heater 13, 14 of the buffer storage volume 8 can be activated if need be in order to increase the pressure in the buffer storage volume 8 to a pressure higher than the pressure in the tank 2. In this way, liquid can be returned to the tank 2 by opening the valve 110 in the first pipe 10. Alternatively or in combination, liquid can be returned to the top of the tank 2 via the second pipe 11 and the return pipe 9 by opening the relevant valves 111, 19.

This transfer of liquid is interrupted when the pressures in the tank 2 and in the buffer storage volume 8 become identical. This process can be recommenced as often as necessary, notably in order to maintain a level of liquid and coldness in the tank 2 with a view to a future pumping operation.

### Cooling of the Pump

Before a pumping operation, the buffer storage volume 8 is preferably full and at a pressure higher than the pressure in the tank 2 and all the valves are closed.

By opening the valves 111, 211, 15 in the second pipe and the suction line 5, cold liquid can be returned to the tank, passing via the pump 3 in order to cool it. The liquid returns to the liquid part where the gas is reliquefied. The increase in pressure is therefore relatively small. When the pump 3 has been cooled sufficiently (this being measured for example by one or more temperature sensors), the pump 3 is ready to be used.

In instances in which the pump 3 is not designed to accept a flow in the reverse direction, a liquid flow may on the other hand be drawn from the tank 2 to the buffer storage volume 8 via the pump 3. This warmed fluid can be liquefied again in the buffer storage volume 8. For this mode of operation, the pressure in the tank 2 needs to be higher than the pressure in the buffer storage volume 8. That can be achieved by increasing the pressure in the tank 2 (via a heater for example) and/or by reducing the pressure in the buffer storage volume 8 (using the liquefaction member 12).

If the pump 3 performance is poor, the liquefaction member 12 and the buffer storage volume 8 may not be specified adequately for liquefying all the gas produced. In that case, gas may be returned to the tank 2 by increasing its pressure with a view to being reliquefied later (cf. hereinabove).

In an extreme case in which the pump 3 vaporizes 3 kg of hydrogen in order to cool it, a buffer storage volume of 400 litres and a cryocooler with a power of 100 watts at 20° C. may be enough to liquefy all the gas produced during the cooling of the pump 3.

The way in which the pump 3 is cooled can be adapted notably according to the level of liquid in the tank.

### Pump Active or Paused (Cold)

When the pump 3 is at the correct temperature it can pump the liquid. The pump 3 can be kept at the correct temperature by directing excess pumped liquid to the buffer storage volume (via the second pipe 11).

Because the cooling power of the liquefaction member 12 exceeds the heat losses of the pump 3, the gas vaporized during pumping can be wholly liquefied in the buffer storage volume 8.

That also applies to instances in which the pump 3 is paused but cold.

The signals supplied by the pressure and temperature sensor or sensors make it possible if appropriate to control the degree of opening of the valve 211 at the degassing outlet of the pump 3. When the buffer storage volume 8 is full, it can be emptied into the tank 2 using the process described hereinabove.

In a conventional installation, when the pump is supplied with insufficiently supercooled liquid, as is generally the case at the end of the emptying of the tank or if the installation has been on prolonged standby, the pump 3 may suffer a loss of priming (risk of cavitation) because the liquid at the inlet to the pump 3 is insufficiently supercooled. This may have detrimental effects on the equipment. In general, priming of the pump is restored by opening the degassing outlet 7 to the atmosphere.

The device makes it possible to avoid this loss of gas. First of all, in phases during which the installation is inactive, the device allows the pressure in the tank 2 and therefore the temperature of the liquid to be lowered/controlled, thus guaranteeing the supercooling of the liquid at the inlet to the pump 3. Alternatively, the priming of the pump 3 can be restored by degassing the pump 3 into the buffer storage volume 8 through the valves 111 and 211 as in the case of cooling described previously, having taken care to lower the pressure in the buffer volume 8 before starting the installation. This can be done without the need to increase the pressure in the tank 2. This can be repeated as long as the pressure in the buffer storage volume 8 remains below the pressure in the tank 2. During these operations, the liquefaction member 12 is in operation and reliquefies the gas. Once the buffer storage volume 8 is full, it is emptied to the tank 2 through the line 10 and the valve 110 so as to become operational in order to be ready for any potential malfunctioning of the pump 3 that would require it to be degassed.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. Device for supplying fluid comprising a source tank (2) for storing gaseous fuel at a cryogenic temperature in the form of a liquid-gas mixture, a cryogenic pump (3), the pump (3) comprising a suction inlet (4) connected to the lower part of the tank (2) via a suction line (5), a high-pressure first outlet (6) intended to supply high-pressure fluid to a user and a degassing second outlet (7) connected to the upper part of the tank (2) via a return pipe (9), the device (1) being characterized in that it comprises a cryogenic buffer storage volume (8), a first pipe (10), distinct from the suction line, connecting the lower part of the buffer storage volume (8) to the tank (2) and a second pipe (11) connecting the upper part of the tank (2) to the buffer storage volume (8), and in that the device comprises a liquefaction member (12) for liquefying the gas in the buffer storage volume (8).

2. Device according to claim 1, characterized in that the second pipe (11) has a first end connected to the upper part of the buffer storage volume (8) and a second end connected to the return pipe (9), which means to say that the buffer storage volume (8) is connected to the tank (2) and to the second outlet (7) of the pump (3) via the return pipe (9).

3. Device according to claim 1 or 2, characterized in that the buffer storage volume (8) comprises at least one heater (13, 14) for selectively heating the fluid contained in the buffer storage volume (8) with a view to increasing the pressure therein.

4. Device according to claim 3, characterized in that the buffer storage volume (8) comprises two heaters (13, 14) arranged respectively in the upper and lower parts of the storage volume.

5. Device according to any one of claims 1 to 4, characterized in that of: the suction line (5), the return pipe (9), the first pipe (10), the second pipe (11), at least one comprises at least one valve (15, 19, 110, 111, 211), notably at least one controlled valve.

6. Device according to claim 5, characterized in that it comprises a data acquisition, storage and processing member (130) connected to the at least one valve (15, 19, 110, 111, 211) and to the liquefaction member (12).

7. Device according to claim 6 combined with either one of claims 3 and 4, characterized in that the data acquisition, storage and processing member (130) is also connected to the heater(s) (13, 14), the data acquisition, storage and processing member (130) being configured to control the liquefaction member (12), the at least one heater (13, 14) and the at least one valve (15, 19, 110, 111, 211) in order to liquefy, in the buffer storage volume (8), at least some of the gas vaporized in the device.

8. Device according to claim 7, characterized in that the data acquisition, storage and processing member (130) is configured to control the liquefaction member (12), the at least one heater (13, 14) and the at least one valve (15, 19, 110, 111, 211) in order to keep the pressure in the tank (2) below a determined threshold pressure.

9. Device according to any one of claims 6 to 8, characterized in that it comprises at least one of the following: a pressure sensor (22) sensing the pressure in the tank (2), a temperature sensor sensing the temperature in the tank (2), a pressure sensor (18) sensing the pressure in the buffer storage volume (8), a temperature sensor sensing the temperature in the buffer storage volume (8), the said at least one sensor (18, 22) being connected to the data acquisition, storage and processing member (130).

10. Device according to any one of claims 7 to 9, characterized in that the pump (3) has a determined suction headloss (NPSH), the data acquisition, storage and processing member (130) being configured to control the liquefaction member (12), the at least one heater (13, 14) and the at least one valve (15, 19, 110, 111, 211) in order to keep the pressure in the tank (2) or in the suction line (5) at least equal to the saturation pressure of the cryogenic fluid increased by the suction headloss (NPSH) of the pump (3) and possibly also increased by the value of the headlosses caused by the pipework of the suction line (5) connecting the tank (1) to the pump (3).

11. Method for supplying fluid using a fluid supply device according to any one of claims 1 to 10, characterized in that it comprises, during a period in which the pump (3) is switched off and when the pressure in the tank (2) reaches a determined threshold, a step of transferring vaporized gas from the tank (2) to the buffer storage volume (8), and a liquefaction step in which transferred gas is liquefied in the buffer storage volume (8) by the liquefaction member (12).

12. Method according to claim 11, characterized in that when the liquid level in the buffer storage volume (8) reaches a set limit level, liquid is transferred from the buffer storage volume (8) to the tank (2).

13. Method according to claim 12, characterized in that at least one transfer of fluid between the buffer storage volume (8) and the tank (2) (in one or both directions) is performed by establishing a pressure differential between the pressures within the buffer storage volume (8) and the tank (2) and by placing these latter in fluidic communication (by the opening of (a) valve(s)).

14. Method according to any one of claims 11 to 13, characterized in that it comprises a step of cooling the pump (3) by transferring liquid from the buffer storage volume (8) to the tank (2) via the second outlet (7) of the pump, the inlet (4) of the pump (3) and the suction pipe (5).

15. Method according to any one of claims 11 to 14, characterized in that it comprises a step of switching on and cooling the pump (3) by transferring liquid from the tank (2) to the buffer storage volume (8) via the suction pipe (5), the inlet (4) of the pump and an outlet (7) of the pump (3), at least part of the gas vaporized in the buffer storage volume (8) being liquefied by the liquefaction member (12).
